(19) United States
(12) Patent Application Publication
(10) Pub. No.: US 2024/0211244 A1
(43) Pub. Date: Jun. 27, 2024

(54) HOUSEHOLD APPLIANCE WITH IMPROVED FIRMWARE UPDATE

(71) Applicant: ELECTROLUX APPLIANCES AKTIEBOLAG, Stockholm (SE)

(72) Inventors: Lucio FABRICI, Porcia (IT); Daniele BIASUTTI, Porcia (IT); Mauro TAIARIOL, Porcia (IT); Livio PLOS, Porcia (IT)

(73) Assignee: ELECTROLUX APPLIANCES AKTIEBOLAG, Stockholm (SE)

(21) Appl. No.: 18/569,715

(22) PCT Filed: Jun. 14, 2021
(86) PCT No.: PCT/EP2021/065990

§ 371 Date: Dec. 13, 2023

(51) Int. Cl. G06F 8/65

(52) U.S. Cl. CPC G06F 8/65

(57) ABSTRACT

A household appliance (100) is proposed. The household appliance (100) comprises a plurality of processing units (PUi,PU) for controlling a plurality of electrically controllable components (Li,L) of the household appliance, a communication module (110) for allowing a communication between the household appliance and an external server (115) through a communication network (120), and an update unit (PU). After reception, at the communication module, of an update data distribution from the external server, the update unit is configured to, based on the update data distribution, initiate a delivery to a processing unit to be updated of a respective firmware update package included in the update data distribution.

### FIELD OF THE INVENTION

The present invention generally relates to a household appliance. More specifically, the present invention relates to a household appliance having firmware update capabilities.

### BACKGROUND OF THE INVENTION

A conventional household appliance comprises a plurality of functional modules. Each functional module may comprise, e.g. arranged on a same “Printed Circuit Board” (PCB), a processing unit and a respective electrically controllable component controlled by it (e.g., an electronic switch, a TRIAC, a power transistor, a heating resistor, an electronic display).

Each processing unit is configured to control the respective electrically controllable component according to a corresponding firmware stored at, and run by, the processing unit. In order to upgrade each processing unit, for example to add configurations, settings and/or functionalities, the corresponding firmware may be subjected to (e.g., periodical) updates, hereinafter referred to as firmware updates.

In order to perform firmware update of a processing unit, the household appliance may comprise a communication unit configured to receive (e.g., through a communication network, such as the Internet) a firmware update package from an external server (e.g., a server of the household appliance manufacturer), and an update unit configured to deliver the firmware update package to a requesting processing unit.

### SUMMARY OF THE INVENTION

The Applicant has found that, in a conventional household appliance, firmware update is not fully satisfactory.

According to the Applicant, this is essentially due to the fact that, in the conventional household appliance, each processing unit periodically requests, to the update unit, an availability of a respective firmware update package (hereinafter, update request).

Indeed, the Applicant has understood that relatively frequent update requests from the processing units may negatively affect an operation of the household appliance (for example, in terms of power consumption and process slow-down), and that relatively infrequent update requests from the processing units may involve non-negligible waiting times for the firmware update packages to be actually installed (which may impair functionalities of the household appliance, especially if the firmware update packages contain critical/security fixes).

The Applicant has devised a household appliance implementing a firmware update aimed at overcoming the above-mentioned drawbacks.

In particular, one or more aspects of the present invention are set out in the independent claims, with advantageous features of the present invention that are indicated in the dependent claims (with any advantageous feature provided with reference to a specific aspect of the present invention that applies mutatis mutandis to any other aspect thereof).

An aspect of the present invention relates to a household appliance. The household appliance may comprise a plurality of processing units for controlling a plurality of electrically controllable components of the household appliance. The household appliance may comprise a communication module for allowing a communication between the household appliance and an external server, e.g. through a communication network. The household appliance may comprise an update unit. After reception, at the communication module, of an update data distribution from the external server, the update unit may be configured to, based on the update data distribution, initiate a delivery to a processing unit to be updated of a respective firmware update package included in the update data distribution. Therefore, the delivery of the firmware update package to the processing unit to be updated is started by the update unit on its own initiative, i.e. it is autonomously started at the earliest opportunity after reception of the update data distribution, and hence without any update request from the processing unit. This allows avoiding update requests from the processing units, which may negatively affect an operation of the household appliance (for example, in terms of power consumption and process slow-down). This also allows avoiding non-negligible waiting times for the firmware update package to be actually installed (which could impair functionalities of the household appliance, especially if the firmware update package contains critical/security fixes).

According to an embodiment, whose features are additional or alternative to any feature of any of the preceding embodiments, after reception, at the communication module, of the update data distribution, the update unit is configured to, based on the update data distribution, initiate an identification of the processing unit to be updated. Therefore, the identification of the processing unit to be updated is started by the update unit on its own initiative, i.e. it is autonomously started by the update unit at the earliest opportunity after reception of the update data distribution, and hence without any update request from the processing unit. This further reduces power consumption and process slow-down of the household appliance, as well as waiting times for the firmware update package to be actually installed.

According to an embodiment, whose features are additional or alternative to any feature of any of the preceding embodiments, the processing units are configured to operate in a first operating mode allowing the processing units to control the electrically controllable components, or in a second operating mode preventing the processing units to control the electrically controllable components. The update unit may be configured to initiate the identification of the processing unit to be updated after activation of the second operating mode in the processing units. Initiating the identification of the processing unit to be updated (and subsequent delivery of the respective firmware update package thereto) after activation of the second operating mode in the processing units, allows performing an update procedure that does not affect a normal operation of the household appliance, and, particularly, that does not involve the electrically controllable component(s) controlled by the processing unit.

According to an embodiment, whose features are additional or alternative to any feature of any of the preceding embodiments, the update unit is configured to cause activation of the second operating mode in the processing units by forcing the processing units to run respective bootloader firmware. The running of the bootloader firmware, and hence of a firmware already provided in the processing units, allows easily and quickly activating the second operating mode in the processing units.

According to an embodiment, whose features are additional or alternative to any feature of any of the preceding embodiments, the update unit is configured to cause the processing unit to be updated to run a software plugin allowing installation of the respective firmware update package delivered thereto. The software plugin allows adding to the bootloader firmware the specific functionality of installation of the firmware update package (e.g., by providing erasing of data associated with an older firmware version, and/or writing of data associated a new firmware version), thus the bootloader firmware may be a lightweight bootloader firmware (i.e., a bootloader firmware that may have a small memory footprint (RAM usage) and low CPU usage, and, more generally, an overall low usage of system resources).

According to an embodiment, whose features are additional or alternative to any feature of any of the preceding embodiments, the software plugin is included in the update data distribution. Therefore, no dedicated processes or operations are required to retrieve the software plugin.

According to an embodiment, whose features are additional or alternative to any feature of any of the preceding embodiments, the update data distribution includes a plurality of firmware update packages each one associated with a respective processing unit of said plurality of processing units. The update unit may be configured to identify the processing unit to be updated as the processing unit whose firmware version is different from the firmware version of the respective firmware update package included in the update data distribution. In other words, the update data distribution is a complete update data distribution, i.e. it comprises firmware update packages for all the processing units, including the processing units whose current firmware versions are already the latest ones: this allows quickly and easily assessing the update availability for each processing unit, and hence quick and easy identification of the processing unit(s) to be updated.

According to an embodiment, whose features are additional or alternative to any feature of any of the preceding embodiments, the update data distribution includes a software component configured to enable, between the update unit and each one of the plurality of processing units, a respective communication line. The software plugin allows adding to the bootloader firmware the specific functionality of enabling a communication line between the update unit and each one of the processing units, thus the bootloader firmware may be a lightweight bootloader firmware (i.e., a bootloader firmware that may have a small memory footprint (RAM usage) and low CPU usage, and, more generally, an overall low usage of system resources). The update unit may be configured to initiate the identification of the processing unit to be updated and delivery of the firmware update package thereto through the respective enabled communication line. This allows avoiding that, during identification and delivery steps involving an addressed processing unit, other processing units are involved.

According to an embodiment, whose features are additional or alternative to any feature of any of the preceding embodiments, the plurality of processing units comprise a first processing unit connected to the update unit through a first electrical connection, and a second processing unit connected to the first processing unit through a second electrical connection. This allows implementing a hierarchical architecture in which, when the processing units are operated in the first operating mode, a master (or primary) device and slave (or secondary) devices are provided, with the master device that may be configured to coordinate an operation of the slave devices and to serve as their communication hub. The enabled communication line between the update unit and the second processing unit may comprise the first electrical connection and the second electrical connection electrically coupled to each other. When the processing units are operated in the second operating mode (and when the update unit acts as a slave device in the first operating mode), this allows easily enabling the communication line between two slave devices without having to actively involve the master device.

According to an embodiment, whose features are additional or alternative to any feature of any of the preceding embodiments, the update unit is configured to cause the first processing unit to receive, install and run the software component after activation of the second operating mode in the first processing unit.

According to an embodiment, whose features are additional or alternative to any feature of any of the preceding embodiments, in the first operating mode the first processing unit and the second processing unit are configured to communicate with each other through the second electrical connection based on a peer-to-peer communication protocol, and in the second operating mode the update unit and the second processing unit are configured to communicate with each other through the enabled communication line based on a point-to-point communication protocol. The use of a point-to-point communication protocol allows addressing, during identification and delivery steps, a single processing unit at once, thus making the update procedure efficient.

According to an embodiment, whose features are additional or alternative to any feature of any of the preceding embodiments, the household appliance is a laundry machine configured to wash and/or dry laundry, a dishwasher, an oven, a refrigerator, or a cooking hob.

### BRIEF DESCRIPTION OF THE ANNEXED DRAWINGS

These and other features and advantages of the present invention will be made apparent by the following description of some exemplary and non-limitative embodiments thereof; for its better intelligibility, the following description should be read making reference to the attached drawings, wherein:

FIG. 1 shows a household appliance according to an embodiment of the present invention, and

FIG. 2 illustrates a flow chart of an update procedure according to an embodiment of the present invention.

### DETAILED DESCRIPTION OF PREFERRED EMBODIMENTS OF THE INVENTION

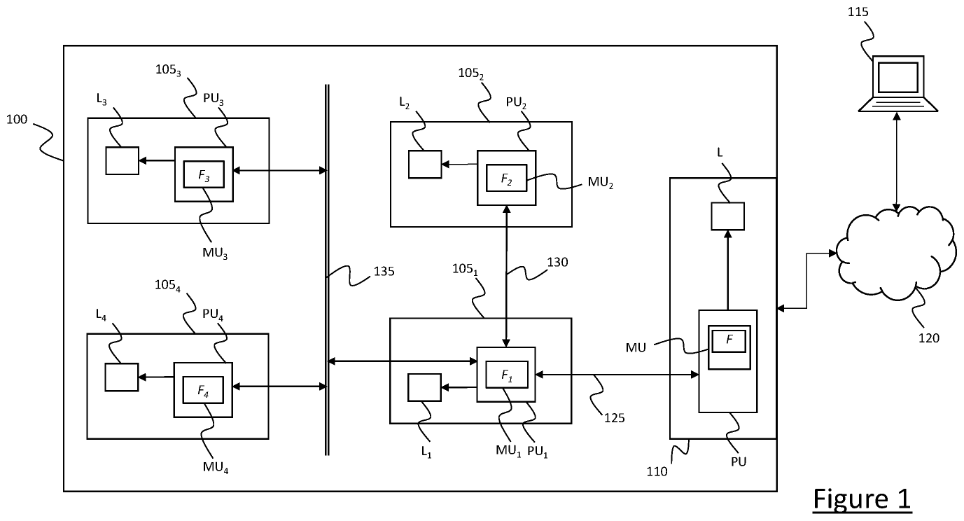

With reference to the drawings, FIG. 1 shows a household appliance 100 according to an embodiment of the present invention.

In the following, when one or more features of the household appliance (as well as method steps implemented by it) are introduced by the wording “according to an embodiment”, they are to be construed as features additional or alternative to any features previously introduced, unless otherwise indicated and/or unless there is evident incompatibility among feature combinations.

According to an embodiment, the household appliance 100 may be a household appliance for domestic or professional use.

According to embodiments, the household appliance 100 may be a laundry machine (i.e., a laundry machine configured to wash and/or dry laundry), a dishwasher, an oven, a refrigerator, or a cooking hob. However, as will be better understood from the following discussion, the present invention may be applied to any household appliance.

According to an embodiment, the household appliance 100 comprises a plurality of processing units PUᵢ (i=1, 2, . . . , I, with I=4 in the example at issue) for controlling a plurality (e.g., a number I) of electrically controllable components Lᵢ of the household appliance 100.

In the exemplary and simplified embodiment herein considered, each processing unit PUᵢ is configured to control a respective electrically controllable component Lᵢ (i.e., with the processing unit PU₁ that is configured to control the electrically controllable component Lᵢ, with the processing unit PU₂ that is configured to control the electrically controllable component L₂, with the processing unit PU₃ that is configured to control the electrically controllable component L₃, and with the processing unit PU₄ that is configured to control the electrically controllable component L₄). However, without losing generality, the principles of the present invention equivalently apply to arrangements wherein a number of electrically controllable components higher than the number of processing units is provided, and wherein each processing unit PUᵢ is configured to control two or more electrically controllable components.

According to an embodiment, each processing unit PUᵢ and the respective electrically controllable component Lᵢ controlled by it are arranged on a respective “Printed Circuit Board” (PCB), and identify, together with the respective PCB, a corresponding functional module 105ᵢ of the household appliance 100.

According to an embodiment, each processing unit PUᵢ may comprise one or more processors or microprocessors and/or one or more controllers or microcontrollers.

According to an embodiment, each electrically controllable component Lᵢ may comprise electric, electronic, electromechanical and/or electrohydraulic components.

Just as an example, in case that the household appliance 100 is a laundry machine configured to wash laundry, the electrically controllable component L₁ may be a user interface (and the corresponding functional module 105₁ may be a user interface module), the electrically controllable component L₂ may be a graphic display unit (and the corresponding module functional 105₂ may be a display module), the electrically controllable component L₃ may be an electronic switch, e.g. for hydraulic valve opening/closing (and the corresponding functional module 105₃ may be a switch module), and the electrically controllable component L₄ may be a heating resistor, e.g. for washing liquid heating (and the corresponding functional module 105₄ may be a heating module).

Just as another example, in case that the household appliance 100 is an oven, the electrically controllable component L₁ may be a user interface (and the corresponding functional module 105₁ may be a user interface module), the electrically controllable component L₂ may be a graphic display unit (and the corresponding functional module 105₂ may be a display module), the electrically controllable component L₃ may be a heating resistor, e.g., for cooking cavity heating (and the corresponding functional module 105₃ may be a heating module), and the electrically controllable component L₄ may be a TRIAC, e.g. for controlling an oven fan (and the corresponding functional module 105₄ may be a TRIAC module).

Just as a further example, in case that the household appliance 100 is a refrigerator, the electrically controllable component L₁ may be a user interface (and the corresponding functional module 105₁ may be a user interface module), the electrically controllable component L₂ may be a graphic display unit (and the corresponding functional module 105₂ may be a display module), the electrically controllable component L₃ may be a TRIAC, e.g. for controlling a refrigerator compressor (and the corresponding functional module 105₃ may be a TRIAC module), and the electrically controllable component L₄ may be a further TRIAC, e.g. for controlling a refrigerator fan (and the corresponding functional module 105₄ may be a further TRIAC module).

According to an embodiment, the household appliance 100 comprises a communication module 110. According to an embodiment, the communication module 110 is configured to allow communication between the household appliance 100 and an external server 115 through a communication network 120 (such as the Internet network).

According to an embodiment, the communication network 120 may comprise a wired and/or a wireless communication network.

Just as an example, the communication module 110 may be configured to access the communication network 120 through a wireless communication link (such as a Wi-Fi communication link) between the communication module 110 and a router (not illustrated in figure), and through a wired communication link between the router and the communication network 120. Just as another example, the communication module 110 may be configured to access the communication network 120 through a cellular communication link between the communication module 110 and the communication network 120.

According to an embodiment, the communication module 110 comprises a processing unit PU. According to an embodiment, the processing unit PU may comprise one or more processors or microprocessors and/or one or more controllers or microcontrollers.

According to an embodiment, the processing unit PU is configured to control an electrically controllable component L (or more thereof) of the communication module 110. According to an embodiment, the electrically controllable component L comprises transceiver devices and/or other electronic devices in charge of establishing wireless communications.

According to an embodiment, the processing unit PU and the respective electrically controllable component L controlled by it are arranged on a respective PCB, and identify, together with the respective PCB, the communication module 110.

In the following, the processing units PUᵢ of the functional modules 105ᵢ and the processing unit PU of the communication module 110 will be concisely referred to as processing units PUᵢ,PU, when distinguishing between them is not relevant for the understanding of the present invention.

According to an embodiment, the processing units PUᵢ,PU are configured to operate in a first operating mode (hereinafter referred to as normal mode) or in a second operating mode (hereinafter referred to as update mode) respectively allowing o preventing the processing units PUᵢ,PU to control the respective electrically controllable components Lᵢ,L.

According to an embodiment, when the processing units PUᵢ,PU are operated in the normal mode, the household appliance 100 is allowed to perform normal functions that involve proper control of the electrically controllable components Lᵢ,L (or at least a subset thereof). Examples of normal functions of the household appliance 100 that involve control of the electrically controllable components Lᵢ, comprise, but are not limited to, laundry washing and/or drying (e.g., when the household appliance 100 is a laundry machine), or food cooking (e.g., when the household appliance 100 is a cooking hob or an oven). Examples of normal functions of the household appliance 100 that involve control of the electrically controllable component L, comprise, but are not limited to, download of laundry cycles (e.g., when the household appliance 100 is a laundry machine), download of cooking recipes (e.g., when the household appliance 100 is a cooking hob or an oven), and download of an update data distribution (as better discussed in the following).

According to an embodiment, when the processing units PUᵢ,PU are operated in the update mode, the household appliance 100 is allowed to perform (e.g., based on the updated data distribution downloaded by the communication module 110, as better discussed in the following) an update procedure aimed at updating one or more of the processing units PUᵢ,PU (e.g., a firmware thereof).

According to an embodiment, each processing unit PUᵢ,PU is configured to control the respective electrically controllable component Lᵢ,L according to a corresponding firmware Fᵢ,F stored at, and run by, the processing unit PUᵢ,PU (i.e., with the processing unit PU₁ that is configured to store and run firmware F₁, with the processing unit PU₂ that is configured to store and run firmware F₂, with the processing unit PU₃ that is configured to store and run firmware F₃, with the processing unit PU₄ that is configured to store and run firmware F₄, and with the processing unit PU that is configured to store and run firmware F).

According to an embodiment, each processing unit PUᵢ,PU comprises a respective memory unit MUᵢ,MU. According to an embodiment, each memory unit MUᵢ,MU is configured to store the corresponding firmware Fᵢ,F.

According to an embodiment, each firmware Fᵢ,F comprises a corresponding application firmware APPᵢ,APP. According to an embodiment, each processing unit PUᵢ,PU is configured to run the respective application firmware APPᵢ,APP for causing that processing unit PUᵢ,PU to operate in the normal mode. Otherwise stated, the running, by each processing unit PUᵢ,PU, of the respective application firmware APPᵢ,APP decrees activation of the normal mode for that processing unit PUᵢ,PU (and, hence, for the corresponding module 105ᵢ,110).

According to an embodiment, each firmware Fᵢ,F comprises a corresponding bootloader firmware BLᵢ,BL. According to an embodiment, each processing unit PUᵢ,PU is configured to run the respective bootloader firmware BLᵢ,BL for causing that processing unit PUᵢ,PU to operate in the update mode. Otherwise stated, the running, by each processing unit PUᵢ,PU, of the respective bootloader firmware BLᵢ,BL decrees activation of the update mode for that processing unit PUᵢ,PU (and, hence, for the corresponding module 105ᵢ,110).

According to an embodiment, each processing unit PUᵢ,PU is configured to invoke (or launch) the respective bootloader firmware BLᵢ,BL at a startup or reboot of that processing unit PUᵢ,PU.

According to an embodiment, each processing unit PUᵢ,PU is configured to start (or launch) the respective bootloader firmware BLᵢ,BL first, and to start (and run) the respective application firmware APPᵢ,APP conditioned to a non-running of the bootloader firmware BLᵢ,BL.

According to an embodiment, if the bootloader firmware BLᵢ,BL is not run before a time-out has elapsed (for example, a time-out from the start of the bootloader firmware BLᵢ,BL), the respective processing unit PUᵢ,PU is configured to launch and run the respective application firmware APPᵢ,APP (which decrees the activation of the normal mode for that processing unit PUᵢ,PU).

According to an embodiment, if the bootloader firmware BLᵢ,BL is run before the time-out has elapsed, the running of the bootloader firmware BLᵢ,BL decrees the activation of the update mode for the respective processing unit PUᵢ,PU. For the purposes of the present disclosure, the running of the bootloader firmware BLᵢ,BL (and, hence, activation of the update mode for the respective processing unit PUᵢ,PU) may be forced by an update unit of the household appliance 100 (discussed in the following), although this should not be construed limitatively.

According to an embodiment, as mentioned above, the communication module 110 is configured to receive (or download) an update data distribution from the external server 115. According to an embodiment, the communication module 110 is configured to store the update data distribution, e.g. in the memory unit MU of the respective processing unit PU.

According to an embodiment, the update data distribution comprises, for each processing unit to be updated, a respective firmware update package.

According to an embodiment, the update data distribution comprises a plurality of firmware update packages each one associated with a respective processing unit.

According to an embodiment, for each processing unit, the respective firmware update package included in the update data distribution may comprise a current version of the respective firmware Fᵢ,F (i.e., the same version of the firmware Fᵢ,F currently installed in that processing unit), hereinafter referred to as current firmware version, or a new version thereof (hereinafter referred to as new firmware version). In other words, in this embodiment the update data distribution is a complete update data distribution, i.e. it comprises firmware update packages for all the processing units PUᵢ,PU, including the processing units PUᵢ,PU whose current firmware versions are already the latest ones.

According to an embodiment, when the update data distribution is a complete update data distribution, the update procedure may comprise firmware update for a subset of the processing units PUᵢ,PU. In this embodiment, the subset of the processing units PUᵢ,PU may comprise each processing unit PUᵢ,PU whose current firmware version is different (e.g. older) than the version of the firmware in the respective firmware update package (hereinafter, update firmware version). In this embodiment, when a processing unit PUᵢ,PU (or more thereof) having current firmware version older than the respective update firmware version is provided (and, hence, the update data distribution comprise a new firmware version for that processing unit PUᵢ,PU), the installation of the firmware update package in that processing unit PUᵢ,PU results in an upgrade of that processing unit PUᵢ,PU to the new firmware version.

According to an embodiment, when the update data distribution is a complete update data distribution, the update procedure may comprise firmware update for all the processing units PUᵢ,PU. In this embodiment, when a processing unit PUᵢ,PU (or more thereof) having same current firmware version as the respective update firmware version is provided, the installation of the firmware update package in that processing unit PUᵢ,PU results in the processing unit PUᵢ,PU remaining at the current firmware version.

According to an embodiment, the processing units to be updated may comprise one or more among the processing units PUᵢ,PU.

According to an embodiment, as better discussed in the following, the processing units to be updated are identified based on the update data distribution. According to an embodiment, a processing unit to be updated may for example be identified as the processing unit whose current firmware version is different (e.g., older) from the respective update firmware version.

According to an embodiment, the update data distribution comprises one or more software components or plugin configured to add specific functionalities to the bootloader firmware BLᵢ,BL.

According to an embodiment, the update data distribution comprises a software component or plugin (hereinafter, referred to as installation plugin) configured to allow, when run in a processing unit to be updated, installation of the respective firmware update package delivered thereto. Just as an example, installation (through the installation plugin) of the firmware update package in a processing unit to be updated may comprise data erasing and/or data writing (such as erasing of data associated with the older firmware version, and/or writing of data associated the new firmware version).

According to an embodiment, the update data distribution comprises a further software component or plugin (hereinafter, referred to as gateway plugin) configured to enable, between an update unit (discussed in the following) and each processing unit, a respective (bidirectional) communication line (hereinafter referred to as enabled communication line). As better discussed in the following, through each enabled communication line, the update unit is allowed to initiate an identification of the processing unit to be updated and/or a delivery of the firmware update package thereto.

According to an embodiment, the communication module 110 is configured to store, e.g. in the memory unit MU of the respective processing unit PU, a backup data distribution, i.e. a copy of the current firmware versions currently installed in the processing units PUᵢ,PU. According to an embodiment, the backup data distribution may be used to restore a correct operation of the household appliance 100 in case of failure of the update procedure.

According to an embodiment, the household appliance 100 comprises an update unit.

According to an embodiment, the update unit may comprise a dedicated unit (not shown).

According to an embodiment, the update unit may comprise one or more elected ones of the processing units PU,PUᵢ. According to an embodiment, the elected processing unit(s) PU,PUᵢ act(s) as the update unit when the elected processing unit(s) PU,PUᵢ is(are) operated in the update mode. In the exemplary considered embodiment, the update unit comprises the processing unit of the communication module 110 (i.e., the processing unit PU), when the processing unit is operated in the update mode.

In FIG. 1, electrical connections among the processing units PUᵢ,PU are depicted. However, these electrical connections are merely exemplary, and are intended to conceptually illustrate the practical case of a hierarchical architecture of the modules 105ᵢ,110 (and, hence of the respective processing units PUᵢ,PU).

In the exemplary hierarchical architecture herein considered, at least one of the processing units PUᵢ, such as the processing unit PU₁, is electrically connected to the processing unit PU through a corresponding electrical connection 125.

According to an embodiment, when the processing unit PU₁ and the processing unit PU are operated in the normal mode, the processing unit PU₁ and the processing unit PU are configured to communicate with each other (through the electrical connection 125) based on a respective dedicated communication protocol. Just as an example, the dedicated communication protocol may comprise the HACL communication protocol.

According to an embodiment, when the processing unit PU₁ and the processing unit PU are operated in the update mode, the enabled communication line between the update unit and the processing unit PU₁ comprises the electrical connection 125. According to an embodiment, when the processing unit PU₁ and the processing unit PU are operated in the update mode, the update unit PU and the processing unit PU₁ are configured to communicate with each other through the enabled communication line based on a point-to-point communication protocol (such as a “Domestic Appliance Acquisition System” (“DAAS”) communication protocol).

In the exemplary hierarchical architecture herein considered, at least one of the processing units PU₂-PU₄, such as the processing unit PU₂, is connected to the processing unit PU₁ through a corresponding electrical connection 130.

According to an embodiment, when the processing unit PU₂ and the processing unit PU₁ are operated in the normal mode, the processing unit PU₂ and the processing unit PU₁ are configured to communicate with each other (through the electrical connection 130) based on a respective dedicated communication protocol.

According to an embodiment, when the processing unit PU₂ and the processing unit PU₁ are operated in the update mode, and when the update unit comprises the processing unit PU, the enabled communication line between the update unit PU and the processing unit PU₂ comprises the electrical connection 125 and the electrical connection 130 electrically coupled to each other. According to an embodiment, as discussed in the following, the enabled communication line between the update unit PU and the processing unit PU₂ is allowed by the gateway plugin installed and running in the processing unit PU₁. According to an embodiment, the update unit PU and the processing unit PU₂ are configured to communicate with each other through the enabled communication line based on a point-to-point communication protocol (such as the DAAS communication protocol).

In the exemplary hierarchical architecture herein considered, at least two of the processing units PU₂-PU₄, such as the processing units PU₃,PU₄, are connected to the processing unit PU₁ through a corresponding electrical connection 135 (for example, a data bus).

According to an embodiment, when the processing units PU₃,PU₄ and the processing unit PU₁ are operated in the normal mode, the processing units PU₃,PU₄ and the processing unit PU₁ are configured to communicate with each other (through the electrical connection 135) based on a peer-to-peer communication protocol. Just as an example, the peer-to-peer communication protocol may comprise the Major MACS (“Major Appliance Communication System”) communication protocol employed in most of the household appliances marketed by the Applicant.

According to an embodiment, when the processing units PU₃,PU₄ and the processing unit PU₁ are operated in the update mode, and when the update unit comprises the processing unit PU, the enabled communication line between the update unit and the processing units PU₃, PU₄ comprises the electrical connection 125 and the electrical connection 135 electrically coupled to each other. According to an embodiment, as better discussed in the following, the enabled communication line between the update unit and the processing units PU₃,PU₄ is allowed by the gateway plugin installed and running in the processing unit PU₁. According to an embodiment, the update unit and the processing units PU₃,PU₄ are configured to communicate with each other through the enabled communication line based on a point-to-point communication protocol (such as the DAAS communication protocol).

In the exemplary hierarchical architecture herein considered, when the processing units PUᵢ,PU are operated in the normal mode, the functional module 105₁ (or, equivalently, the corresponding processing unit PU₁) acts as a master (or primary) device, and the functional modules 105₂-105₄,110 (or, equivalently, the corresponding processing units P₂-P₄,PU) act as slave (or secondary) devices, e.g. with the master device that is configured to coordinate an operation of the slave devices and to serve as their communication hub.

In the exemplary hierarchical architecture herein considered, when the processing units PUᵢ,PU are operated in the update mode, and when the update unit comprises the processing unit PU, any processing unit directly connected to the update unit (such as the processing unit PU₁ directly connected to the processing unit PU through the direct electrical connection 125) acts as a first-order processing unit with respect to the update unit, and any processing unit not directly connected to the update unit (such as the processing unit PU₂, which is directly connected to the processing unit PU₁ through the electrical connection 130, and the processing units PU₃,PU₄, which are directly connected to the processing unit PU₁ through the electrical connection 135) as act as a second-order processing unit with respect to the update unit.

According to an embodiment, after reception, at the communication module 110, of the update data distribution, the update unit is configured to, based on the update data distribution, initiate a delivery to each processing unit to be updated of the respective firmware update package.

For the purposes of the present disclosure, by initiating a delivery to a processing unit to be updated of the respective firmware update package it is herein meant that the delivery of the firmware update package to the processing unit to be updated is started by the update unit on its own initiative, i.e. it is autonomously started by the update unit at the earliest opportunity after reception of the update data distribution, and hence without any update request from the processing unit.

Therefore, contrary to the known solutions wherein each processing unit periodically requests, to the update unit, an availability of respective firmware update package (update request), the update procedure according to the present invention implements a functionality (hereinafter, push functionality) wherein the firmware update package is autonomously transmitted by the update unit on its own initiative. This allows avoiding update requests from the processing units, which may negatively affect an operation of the household appliance (for example, in terms of power consumption and process slow-down). This also allows avoiding non-negligible waiting times for the firmware update package to be actually installed (which could impair functionalities of the household appliance, especially if the firmware update package contains critical/security fixes).

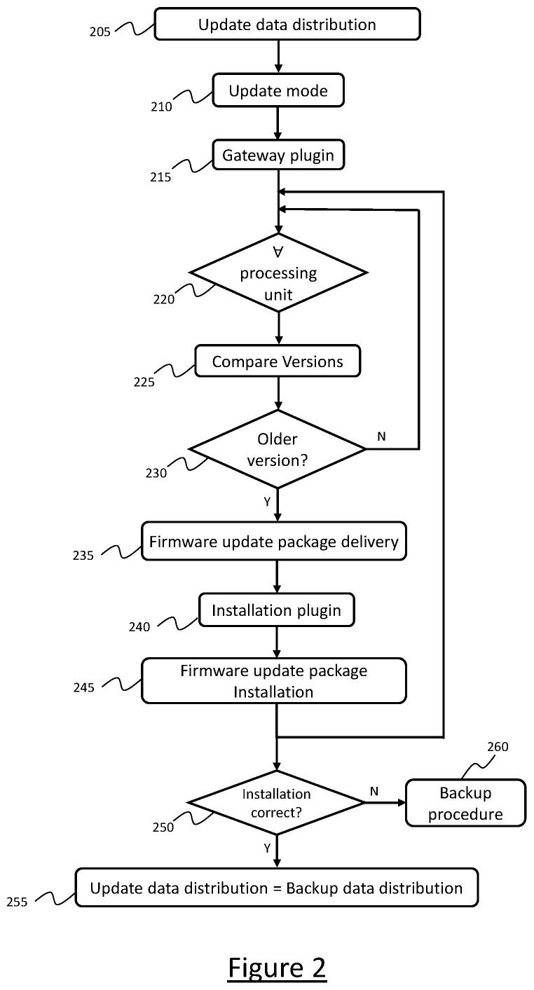

FIG. 2 illustrates a flow chart of an update procedure 200 according to an embodiment of the present invention.

According to an embodiment, the update procedure 200 comprises receiving, at the communication module 110, the update data distribution from the external server 115 (action node 205).

According to an embodiment, as mentioned above, reception of the update data distribution comprises a download of the update data distribution through the communication network 120.

According to an embodiment, reception of the update data distribution takes place upon assessing the presence of an update data distribution availability at the external server 115. According to an embodiment, the communication module 110 is configured to (e.g., periodically) interrogate the external server 115 (e.g., through the communication network 120) about the update data distribution availability.

According to an embodiment, as mentioned above, the (received or downloaded) updated data distribution is stored in the memory unit MU of the processing unit PU.

According to an embodiment, reception of the update data distribution takes place when the processing units PUᵢ,PU operate in the normal mode. According to an embodiment, reception of the update data distribution takes place as a background process, i.e. a process that does not require user presence or intervention.

According to an embodiment, reception of the update data distribution may also comprise reception of the backup data distribution (e.g., if no backup data distribution is already available in the household appliance 100, such as if no backup data distribution is already available in the memory unit MU).

According to an embodiment, the update procedure 200 comprises activating the update mode in the processing units PUᵢ,PU (action node 210).

According to an embodiment, activation of the update mode in the processing units PUᵢ,PU is achieved by forcing the running of the bootloader firmware BLᵢ,BL in the processing units PUᵢ,PU (as discussed above).

According to an embodiment, the activation of the update mode in the processing units PUᵢ,PU is performed by the master device, for example by the processing unit PU₁. Just as an example, the processing unit PU₁ may be configured to force a reboot of the processing units PUᵢ,PU (including the processing unit PU₁ itself) and to cause a running of the respective bootloader firmware BLᵢ,BL before the time-out has elapsed.

As mentioned above, as a result of activation of the update mode in the processing units PUᵢ,PU, one of the processing units PUᵢ,PU, such as the processing unit PU, acts as the update unit for the following of the update procedure.

According to an embodiment, activation of the update mode may be conditioned to user approval.

According to an embodiment, activation of the update mode may be conditioned to one or more security actions.

According to an embodiment, the security actions may comprise a disablement of the communication between the household appliance 100 and the communication network 120 (for example, by deactivating the electrically controllable component L (i.e., the transceiver devices and/or other electronic devices in charge of establishing wireless communications) of the communication module 110). In doing so, undesired external events and/or unauthorized accesses to the household appliance 100 may be prevented during the following steps of the update procedure 200, thus increasing a reliability thereof.

According to an embodiment, the security actions may comprise verify actions aimed at verifying an integrity of the update data distribution (e.g., in order to avoid installations based on a corrupted and/or incomplete update data distribution).

According to an embodiment, the security actions may comprise verify actions aimed at verifying an authenticity of the update data distribution, for example by verifying (preferably, by means of a proper certificate) a digital signature protecting the update data distribution, and/or by verifying a validity of said certificate.

According to an embodiment, the verify actions may also be aimed at verifying integrity and/or authenticity of the backup data distribution.

According to an embodiment, the update procedure 200 comprises, at the update unit, initiating an identification of each processing unit to be updated (action nodes 215-220).

For the purposes of the present disclosure, by initiating an identification of each processing unit to be updated it is herein meant that the identification of processing unit to be updated is started by the update unit on its own initiative, i.e. it is autonomously started by the update unit at the earliest opportunity after reception of the update data distribution, and hence without any update request from the processing unit.

According to an embodiment, as mentioned above, the identification of each processing unit to be updated (and subsequent delivery of the firmware update package thereto) is performed through the respective enabled communication line.

According to an embodiment, said initiating an identification of each processing unit to be updated comprises causing the first-order processing units (in the example at issue, the processing unit PU₁) to receive (from the update unit), install and run the gateway plugin included in the update data distribution.

According to an embodiment, as mentioned above, the enabled communication line between the update unit and a first-order processing unit (the processing unit P₁, in the example at issue) may be allowed by the gateway plugin run in the first-order processing unit. According to an embodiment, as mentioned above, when the processing units PUᵢ,PU are operated in the update mode, the update unit may communicate with the first-order processing unit through the respective enabled communication line and according to the point-to-point communication protocol (such as for example the DAAS communication protocol).

According to an embodiment, as mentioned above, the enabled communication line between the update unit and each second-order processing unit (the processing units P₂-P₄, in the example at issue) is allowed by the gateway plugin run in the first-order processing unit (in the example at issue, the processing unit PU₁). Otherwise stated, when the processing units PUᵢ,PU are operated in the update mode, the update unit may communicate with each second-order processing unit through the enabled communication lines being enabled by the gateway plugin running in the first-order processing unit. In other words, when the processing units PUᵢ,PU are operated in the update mode, the first-order processing unit (through the gateway plugin running in it) allows routing communications between the update unit and a second-order processing unit. According to an embodiment, as mentioned above, when the processing units PUᵢ,PU are operated in the update mode, the update unit PU may communicate with each second-order processing unit through the respective enabled communication line and according to the point-to-point communication protocol (such as for example the DAAS communication protocol).

As mentioned above, according to an embodiment, the update unit is configured to identify the processing unit to be updated (and subsequent delivery of the respective firmware update package thereto).

According to an embodiment, the following steps of identification of the processing units to be updated (and subsequent delivery of the firmware update package thereto) are performed by addressing each processing unit at a time. This is conceptually represented in the figure by decision node 220.

As mentioned above, according to an embodiment, the update unit is configured to identify the addressed processing unit as a processing unit to be updated (and to subsequent delivery the respective firmware update package thereto) based on the update data distribution (action node 225). According to an embodiment, the update unit is configured to identify the addressed processing unit as a processing unit to be updated (and to subsequent delivery the respective firmware update package thereto) based on a comparison between firmware versions. According to an embodiment, the update unit is configured to identify the addressed processing unit as a processing unit to be updated (and to subsequent delivery the respective firmware update package thereto) if the current firmware version of the addressed processing unit is different from (e.g., older than) the update firmware version (of the respective firmware update package included in the update data distribution).

According to an embodiment, for each addressed processing unit, if the current firmware version of that processing unit is older than the respective update firmware version (exit branch Y of decision node 230), the addressed processing unit is identified as a processing unit to be updated. Otherwise, exit branch N of decision node 230, another processing unit is addressed (as conceptually represented in the figure by loop connection between exit branch N of decision node 230 and decision node 220).

As should be understood, nodes 225-230 may be omitted in embodiments of the present invention in which firmware update is envisaged for all the processing units indistinctly (i.e., regardless of the fact that, for each addressed processing unit, the corresponding update firmware package comprises the current firmware version or a new firmware version).

According to an embodiment, the update procedure 200 comprises, at the update unit, delivering (action node 235) the respective firmware update package to the addressed processing unit (which, in the exemplary considered update procedure, corresponds to a processing unit to be updated).

According to an embodiment, the update procedure 200 comprises, at the update unit, delivering the installation plugin to the addressed processing unit (which, in the exemplary considered update procedure, corresponds to a processing unit to be updated), and, at the addressed processing unit, to run the received installation plugin (action node 240).

According to an embodiment, as mentioned above, the installation plugin is transmitted to the addressed processing unit through the respective enabled communication line according to the point-to-point communication protocol, such as for example the DAAS communication protocol.

According to an embodiment, the update procedure 200 comprises, at the addressed processing unit, installing the received firmware update package (action node 245), e.g. by exploiting the installation plugin functionalities.

As mentioned above, according to an embodiment, nodes 220-245 are performed for each addressed processing unit. This is conceptually represented in the figure by loop connection between action node 245 and decision node 220.

According to an embodiment, the update procedure 200 may comprise checking whether the firmware update package(s) has(have) been correctly installed in the respective processing unit(s) (decision node 250).

According to an embodiment, if the firmware update package(s) has(have) been correctly installed in the respective processing unit(s) (exit branch Y of the decision node 250), the update unit may be configured to store (e.g., in the memory unit MU of the processing unit PU) a new backup data distribution in place of the previously stored backup data distribution. In the example herein considered in which the update data distribution received from the external server 115 comprises the firmware update packages for all the processing units PUᵢ,PU, the update data distribution may also be exploited as a new backup data distribution (in which case, no further operations are required).

According to an embodiment, if the firmware update package(s) has(have) not been correctly installed in the respective processing unit(s) (exit branch N of the decision node 250), a backup procedure may be started (action node 260), e.g. by the update unit or by a dedicated unit (not shown) of the household appliance 100. According to an embodiment, the backup procedure may be based on the backup data distribution. According to an embodiment, the backup procedure comprises installing, in the processing units PUᵢ,PU, the firmware update packages contained in the backup data distribution (so as to restore the last correctly-operating firmware versions in the processing units PUᵢ,PU). According to an embodiment, the backup procedure may be performed according to nodes 205-245 (or at least a subset thereof).

According to an embodiment, after installation of the firmware update packages contained in the update data distribution or in the backup data distribution, the update procedure 200 ends, whereby the normal mode in the processing units PUᵢ,PU may be restored.

Naturally, in order to satisfy local and specific requirements, a person skilled in the art may apply to the solution described above many logical and/or physical modifications and alterations. More specifically, although the present invention has been described with a certain degree of particularity with reference to preferred embodiments thereof, it should be understood that various omissions, substitutions and changes in the form and details as well as other embodiments are possible. In particular, different embodiments of the invention may even be practiced without the specific details set forth in the preceding description for providing a more thorough understanding thereof; on the contrary, well-known features may have been omitted or simplified in order not to encumber the description with unnecessary details. Moreover, it is expressly intended that specific elements and/or method steps described in connection with any disclosed embodiment of the invention may be incorporated in other embodiments.

1. A household appliance comprising:
a plurality of processing units for controlling a plurality of electrically controllable components of the household appliance;
a communication module for allowing a communication between the household appliance and an external server through a communication network; and
an update unit, wherein the update unit is configured to, after reception, at the communication module, of an update data distribution from the external server and based on the update data distribution, initiate a delivery to a processing unit to be updated of a respective firmware update package included in the update data distribution.

2. The household appliance according to claim 1, wherein, the update unit is configured to, after reception, at the communication module, of the update data distribution and based on the update data distribution, initiate an identification of the processing unit to be updated.

3. The household appliance according to claim 2, wherein:
the processing units are configured to:
operate in a first operating mode allowing the processing units to control the electrically controllable components; or
operate in a second operating mode preventing the processing units to control the electrically controllable components; and
the update unit is configured to initiate the identification of the processing unit to be updated after activation of the second operating mode in the processing units.

4. The household appliance according to claim 3, wherein the update unit is configured to cause activation of the second operating mode in the processing units by forcing the processing units to run respective bootloader firmware.

5. The household appliance according to claim 1, wherein the update unit is configured to cause the processing unit to be updated to run a software plugin allowing installation of the respective firmware update package delivered thereto.

6. The household appliance according to claim 5, wherein the software plugin is included in the update data distribution.

7. The household appliance according to claim 2, wherein the update data distribution includes a plurality of firmware update packages each one associated with a respective processing unit of said plurality of processing units, and wherein the update unit is configured to identify the processing unit to be updated as the processing unit whose firmware version is different from the firmware version of the respective firmware update package included in the update data distribution.

8. The household appliance according to claim 2, wherein the update data distribution includes a software component configured to enable, between the update unit and each one of the plurality of processing units, a respective enabled communication line, and wherein the update unit is configured to initiate the identification of the processing unit to be updated and delivery of the respective firmware update package thereto through the respective enabled communication line.

9. The household appliance according to claim 8, wherein the plurality of processing units comprise:
a first processing unit connected to the update unit through a first electrical connection; and
a second processing unit connected to the first processing unit through a second electrical connection, wherein the respective enabled communication line between the update unit and the second processing unit comprises the first electrical connection and the second electrical connection being electrically coupled to each other.

10. The household appliance according to claim 9, wherein the update unit is configured to cause the first processing unit to receive, install and run the software component after activation of a second operating mode in the first processing unit.

11. The household appliance according to claim 9, wherein the processing units are configured to:
operate in a first operating mode, wherein the first processing unit and the second processing unit are configured to communicate with each other through the second electrical connection based on a peer-to-peer communication protocol; and
operate in a second operating mode, wherein the update unit and the second processing unit are configured to communicate with each other through the respective enabled communication line based on a point-to-point communication protocol.

12. The household appliance according to claim 1, wherein the household appliance is a laundry machine configured to wash and/or dry laundry, a dishwasher, an oven, a refrigerator, or a cooking hob.
